(19) United States
(12) Patent Application Publication
(10) Pub. No.: US 2025/0332881 A1
(43) Pub. Date: Oct. 30, 2025

(54) METHOD OF OPERATING VEHICLE

(71) Applicants: HYUNDAI MOTOR COMPANY, Seoul (KR); Kia Corporation, Seoul (KR)

(72) Inventors: Min Seong KIM, Hwaseong-si (KR); Myung Hwan KIM, Hwaseong-si (KR)

(73) Assignees: HYUNDAI MOTOR COMPANY, Seoul (KR); Kia Corporation, Seoul (KR)

(21) Appl. No.: 18/970,515

(22) Filed: Dec. 5, 2024

(30) Foreign Application Priority Data
Apr. 24, 2024 (KR) 10-2024-0054896

(51) Int. Cl. B60H 1/00

(52) U.S. Cl. CPC B60H 1/00278; B60H 1/00914; B60H 2001/00928; B60H 2001/00949

(57) ABSTRACT

A method of operating a vehicle, which includes a cooling line through which a first heat-exchange fluid for cooling a cooling target component portion flows, a vehicle air conditioning line through which a second heat-exchange fluid, flows, and a connection line extending from the cooling line toward the vehicle air conditioning line and configured to define a region in which the first heat-exchange fluid and the second heat-exchange fluid exchange heat with each other, includes allowing the first heat-exchange fluid in the cooling line to exchange heat with the cooling target component portion, supplying the first heat-exchange fluid to the connection line, and cooling the first heat-exchange fluid by allowing the first heat-exchange fluid to exchange heat with the second heat-exchange fluid in the connection line.

### CROSS-REFERENCE TO RELATED APPLICATION

The present application claims priority to Korean Patent Application No. 10-2024-0054896 filed on Apr. 24, 2024, the entire contents of which is incorporated herein for all purposes by this reference.

### BACKGROUND OF THE PRESENT DISCLOSURE

### Field of the Present Disclosure

The present disclosure relates to a method of operating a vehicle, and more particularly, to a method of operating a vehicle provided with a cooling apparatus configured for cooling motorization equipment in the vehicle.

### Description of Related art

An electric vehicle, which operates wheels by use of electrical energy of a battery as a power source, needs to effectively dissipate heat generated from the battery as well as heat generated from motors that operate the wheels. In many cases, a radiator is mounted in the electric vehicle to recover heat from heat generation components, including the battery and the motor, and discharge the heat to the outside thereof. Meanwhile, to meet increasing demands for aesthetic design of vehicles, studies are being actively conducted to improve the aesthetic appearances of the vehicles.

However, generally, in case that the radiator is mounted in the vehicle, a volume occupied by the radiator severely restricts the design of the vehicle. In particular, in case that the radiator is mounted in the vehicle, it is impossible to reduce a height of a platform of the vehicle or design a platform having an overall flat shape. Furthermore, in case that the radiator is mounted in the vehicle, a bumper hole, through which cooling air is introduced, needs to be formed in the vicinity of the radiator. However, the bumper hole also degrades not only the aesthetic appearance of the vehicle but also overall aerodynamic performance of the vehicle.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a novel cooling system configured for cooling components without a component cooling radiator mounted in a vehicle in the related art.

To achieve the above-mentioned object, one aspect of the present disclosure provides a method of operating a vehicle, which includes a cooling line through which a first heat-exchange fluid for cooling a cooling target component portion flows, a vehicle air conditioning line through which a second heat-exchange fluid, which heats or cools an internal space of the vehicle while exchanging heat with the internal space of the vehicle, flows, and a connection line extending from the cooling line toward the vehicle air conditioning line and configured to define a region in which the first heat-exchange fluid and the second heat-exchange fluid exchange heat with each other, the method including: a component cooling step of allowing the first heat-exchange fluid in the cooling line to exchange heat with the cooling target component portion, supplying the first heat-exchange fluid to the connection line, and cooling the first heat-exchange fluid by allowing the first heat-exchange fluid to exchange heat with the second heat-exchange fluid in the connection line.

In the vehicle internal component cooling step, the second heat-exchange fluid may be discharged from a condenser mounted in the vehicle air conditioning line and then introduced into a chiller portion mounted in the vehicle air conditioning line, and the first heat-exchange fluid and the second heat-exchange fluid may exchange heat with each other in the chiller portion.

In the vehicle internal component cooling step, the second heat-exchange fluid discharged from the condenser may pass through a branch expansion valve mounted in the vehicle air conditioning line and then be introduced into the chiller portion.

The cooling target component portion may include: a first cooling target component portion; and a second cooling target component portion mounted separately from the first cooling target component portion, and in the vehicle internal component cooling step, the first heat-exchange fluid may selectively exchange heat with the first cooling target component portion or the second cooling target component portion and then be supplied to the connection line.

The cooling target component portion may include: a first cooling target component portion; and a second cooling target component portion property separately from the first cooling target component portion, and in the vehicle internal component cooling step, the first heat-exchange fluid may sequentially exchange heat with the second cooling target component portion and the first cooling target component portion and then be supplied to the connection line.

The first cooling target component portion may include at least one of an ICCU, an inverter, and an oil cooler, and the second cooling target component portion may include a battery.

In the vehicle internal component cooling step, the first heat-exchange fluid may exchange heat with the cooling target component portion in a front lower region of the vehicle, and the second heat-exchange fluid may flow in an upper region of the vehicle.

In the vehicle internal component cooling step, the first heat-exchange fluid may exchange heat with the second heat-exchange fluid while flowing in the upper region of the vehicle through the connection line.

The method may further include: a vehicle cooling step of cooling the internal space of the vehicle by allowing the second heat-exchange fluid to flow in the internal space of the vehicle, in which the vehicle internal component cooling step and the vehicle cooling step are performed at least partially together in a time series manner.

When the vehicle internal component cooling step and the vehicle cooling step are performed together in a time series manner, the vehicle cooling step may include allowing a part of the second heat-exchange fluid, which is discharged from a condenser mounted in the vehicle air conditioning line, to sequentially pass through a main expansion valve, an evaporator, and a compressor mounted in the vehicle air conditioning line, and the vehicle internal component cooling step may include introducing another part of the second heat-exchange fluid discharged from the condenser into a chiller portion mounted in the vehicle air conditioning line.

The method may further include: a vehicle heating step of heating the internal space of the vehicle by allowing the second heat-exchange fluid to flow in the internal space of the vehicle, in which the vehicle internal component cooling step and the vehicle heating step are performed at least partially together in a time series manner.

When the vehicle internal component cooling step and the vehicle heating step are performed together in a time series manner, the vehicle internal component cooling step and the vehicle heating step may include allowing at least a part of the second heat-exchange fluid, which is discharged from a condenser mounted in the vehicle air conditioning line, to sequentially pass through a branch expansion valve, a chiller portion, a compressor, and a heat pump condenser mounted in the vehicle air conditioning line, allowing the second heat-exchange fluid to exchange heat with the first heat-exchange fluid in the chiller portion, and then supplying thermal energy to the internal space of the vehicle from the heat pump condenser.

The method may further include: a vehicle heating step of heating the internal space of the vehicle by allowing the second heat-exchange fluid to flow in the internal space of the vehicle, in which the vehicle heating step includes allowing the second heat-exchange fluid to sequentially pass through an evaporator, a compressor, a heat pump condenser, and a bypass line expansion valve mounted in the vehicle air conditioning line, and supplying thermal energy to the internal space of the vehicle from the heat pump condenser.

According to an exemplary embodiment of the present disclosure, it is possible to provide the novel cooling system capable of cooling the components without a component cooling radiator mounted in a vehicle in the related art.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a cross-sectional side view schematically illustrating a cross-sectional structure of a vehicle according to an exemplary embodiment of the present disclosure.

FIG. 2 is a view schematically illustrating a cooling line, a vehicle air conditioning line, a connection line, and components mounted in the lines mounted in the vehicle according to an exemplary embodiment of the present disclosure.

FIG. 3 is a side view exemplarily illustrating a cooling target component portion and the cooling line mounted in the vehicle according to an exemplary embodiment of the present disclosure.

FIG. 4 is a perspective view exemplarily illustrating an air conditioner portion and a vehicle air conditioning line mounted in the vehicle according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, a vehicle according to an exemplary embodiment of the present disclosure will be described with reference to the drawings.

### Vehicle

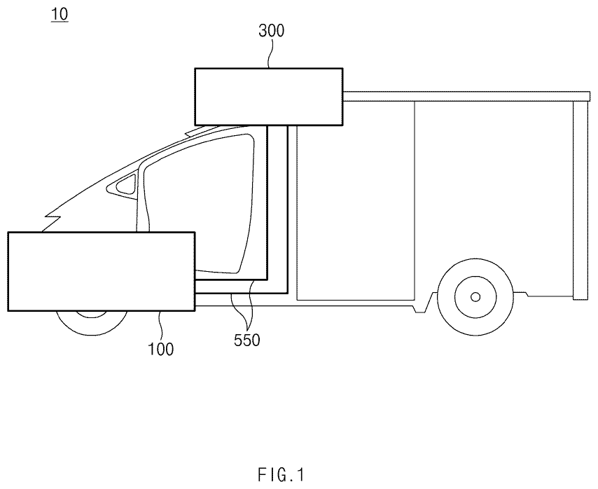

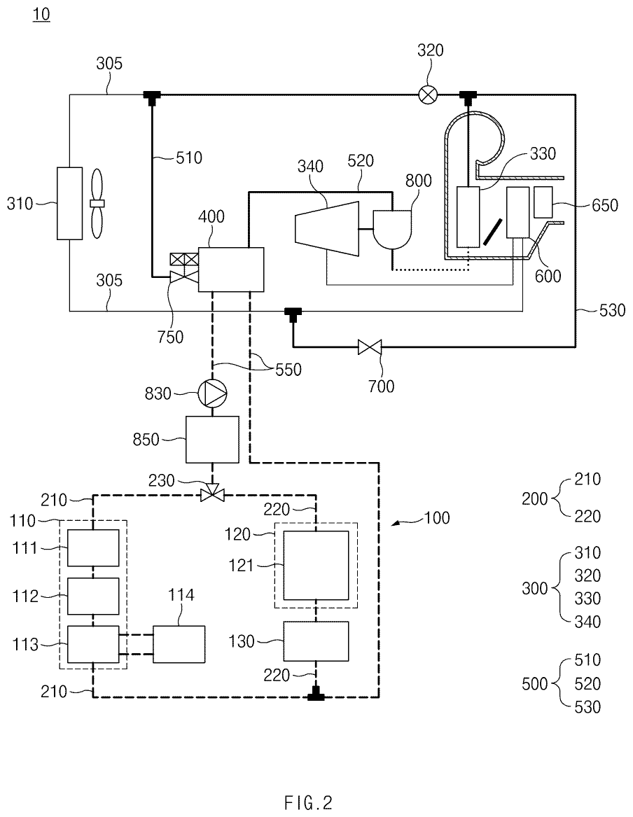

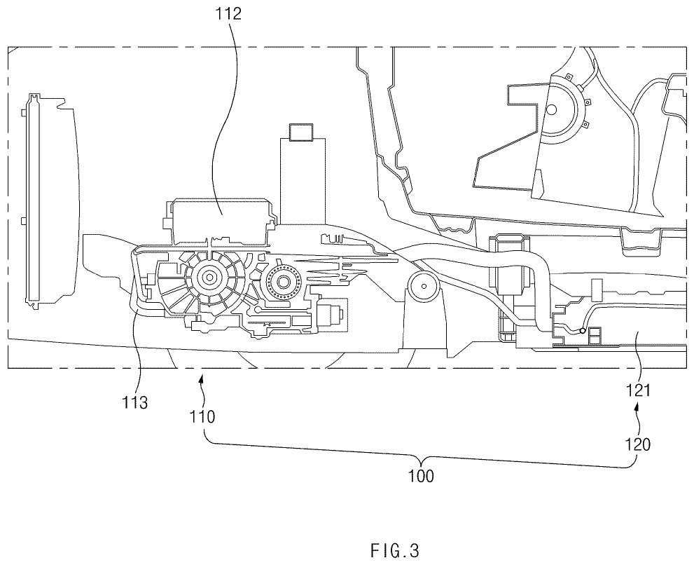

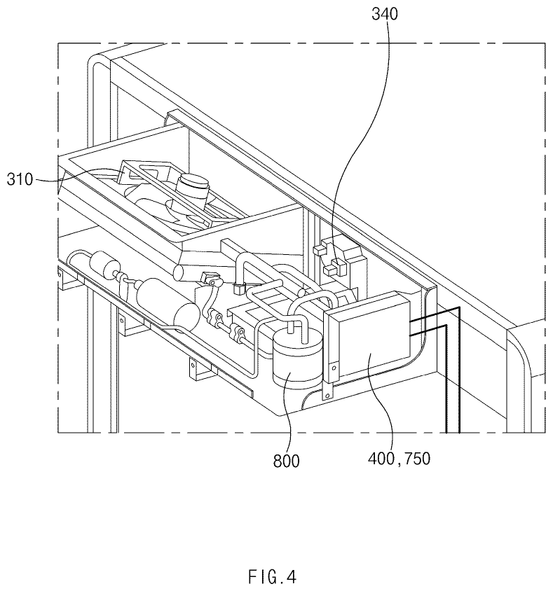

FIG. 1 is a cross-sectional side view schematically illustrating a cross-sectional structure of a vehicle according to an exemplary embodiment of the present disclosure, and FIG. 2 is a view schematically illustrating a cooling line, a vehicle air conditioning line, a connection line, and components mounted in the lines mounted in the vehicle according to an exemplary embodiment of the present disclosure. FIG. 3 is a side view exemplarily illustrating a cooling target component portion and the cooling line mounted in the vehicle according to an exemplary embodiment of the present disclosure, and FIG. 4 is a perspective view exemplarily illustrating an air conditioner portion and a vehicle air conditioning line mounted in the vehicle according to an exemplary embodiment of the present disclosure.

According to an exemplary embodiment of the present disclosure, an air conditioner, which is mounted in a vehicle, may be used to cool a cooling fluid (e.g., a coolant) that cools cooling target components required to be cooled in the vehicle. Therefore, according to an exemplary embodiment of the present disclosure, it is possible to cool the cooling fluid without a separate radiator for cooling the cooling fluid that cools the cooling target components. Therefore, according to an exemplary embodiment of the present disclosure, the radiator may be excluded from the vehicle, which may reduce an overall volume of the vehicle and improve utilization of an internal space of the vehicle. Furthermore, according to an exemplary embodiment of the present disclosure, it is possible to reduce a height of a platform of the vehicle in comparison with a height of a platform of a vehicle in which a radiator in the related art is mounted. Furthermore, it is possible to also improve a degree of design freedom of the vehicle that has been restricted by the radiator.

With reference to the drawings, to achieve the above-mentioned object, according to an exemplary embodiment of the present disclosure, a vehicle 10 according to an exemplary embodiment of the present disclosure may include a cooling target component portion 100 required to be cooled, and a cooling line 200 through which a first heat-exchange fluid for cooling the cooling target component portion 100 flows. The above-mentioned first heat-exchange fluid may be a coolant. Meanwhile, the vehicle 10 according to an exemplary embodiment of the present disclosure may be an electric vehicle that operates wheels by use of electrical energy, which is stored in a battery, as a power source. In the instant case, the cooling target component portion 100 may include at least one of an integrated charging control unit (ICCU) 111, an inverter 112, an oil cooler 113, and a battery 121. For example, the oil cooler 113 may be configured to cool oil for cooling a motor 114 mounted in the vehicle.

Furthermore, the vehicle 10 according to an exemplary embodiment of the present disclosure may further include a vehicle air conditioning line 500 through which a second heat-exchange fluid, which heats or cools an internal space of the vehicle while exchanging heat with the internal space of vehicle, flows, and an air conditioner portion 300 mounted in the vehicle air conditioning line 500. The air conditioner portion 300 may be configured to lower a temperature of the internal space of the vehicle by absorbing thermal energy from the internal space of the vehicle. However, as described below, the vehicle air conditioning line 500 may further include a configuration for raising a temperature of the internal space of the vehicle in addition to the air conditioner portion 300 for lowering a temperature of the internal space of the vehicle. For example, the second heat-exchange fluid may be a refrigerant generally used for an air conditioner for a vehicle.

Meanwhile, as described above, according to an exemplary embodiment of the present disclosure, it is possible to cool the cooling fluid without a separate radiator for cooling the cooling fluid that cools the cooling target components. To achieve the above-mentioned object, the vehicle 10 according to an exemplary embodiment of the present disclosure may further include a connection line 550 extending from the cooling line 200 toward the vehicle air conditioning line 500 and configured to define a region in which the first heat-exchange fluid and the second heat-exchange fluid exchange heat with each other. The first heat-exchange fluid may be supplied to the cooling line 200 through the connection line 550, and the first heat-exchange fluid and the second heat-exchange fluid exchange heat with each other in one region of the connection line 550 so that the first heat-exchange fluid may be cooled, and the second heat-exchange fluid may be heated.

Meanwhile, as illustrated in FIGS. 1, 3, and 4, the vehicle air conditioning line 500 and the air conditioner portion 300 may be mounted in an upper region of the vehicle, and the cooling line 200 and the cooling target component portion 100 may be mounted in a front lower region of the vehicle. Therefore, the connection line 550 may include a region that penetrates the vehicle 10 in a forward/rearward direction and an upward/downward direction of the vehicle so that the first heat-exchange fluid moves from the cooling line 200 toward the vehicle air conditioning line 500.

For example, as illustrated in FIG. 1, the connection line 550 may be mounted to sequentially pass through a driver seat rear region of the vehicle 10 and a driver seat lower region of the vehicle. For example, the connection line 550 may be fixed to a B-pillar of the vehicle 10 and/or a floor member of the vehicle.

With continued reference to the drawings, the vehicle 10 according to an exemplary embodiment of the present disclosure may further include the air conditioner portion 300 mounted in the vehicle air conditioning line 500. As described above, the air conditioner portion 300 may be configured to lower a temperature of the internal space of the vehicle.

The air conditioner portion 300 may include a condenser 310 mounted in the vehicle air conditioning line 500 and configured to discharge heat from the second heat-exchange fluid to the outside thereof, and a main expansion valve 320 connected to the condenser 310 through the vehicle air conditioning line 500 and configured to receive the first heat-exchange fluid discharged from the condenser 310. As the second heat-exchange fluid throttled in the main expansion valve 320 so that a pressure of the second heat-exchange fluid may be rapidly decreased, and a temperature of the second heat-exchange fluid may also be decreased. For example, the main expansion valve 320 may be a thermal expansion valve.

Furthermore, the air conditioner portion 300 may further include an evaporator 330 mounted in the vehicle air conditioning line 500, connected to the main expansion valve 320 through the vehicle air conditioning line 500, and configured to receive the second heat-exchange fluid discharged from the main expansion valve 320, and a compressor 340 mounted in the vehicle air conditioning line 500, connected to the evaporator 330 through the vehicle air conditioning line 500, and configured to receive the second heat-exchange fluid discharged from the evaporator 330.

Meanwhile, the first heat-exchange fluid, which is supplied to the vehicle air conditioning line 500 through the connection line 550, may exchange heat with the second heat-exchange fluid in the configuration disposed in the vehicle air conditioning line 500.

As illustrated in FIG. 2, the vehicle 10 according to an exemplary embodiment of the present disclosure may further include a chiller portion 400 mounted in the vehicle air conditioning line 500 and configured to receive the second heat-exchange fluid from the air conditioner portion 300 through the vehicle air conditioning line 500 and then discharge the second heat-exchange fluid to the air conditioner portion 300 through the vehicle air conditioning line 500. In the instant case, according to an exemplary embodiment of the present disclosure, the connection line 550 is mounted to pass through the chiller portion 400 so that the first heat-exchange fluid and the second heat-exchange fluid may exchange heat with each other in the chiller portion 400.

With reference to FIG. 2, the first heat-exchange fluid is introduced into the chiller portion 400 through the connection line 550, and the second heat-exchange fluid is introduced into the chiller portion 400 through the vehicle air conditioning line 500. Thereafter, the first heat-exchange fluid and the second heat-exchange fluid may exchange heat with each other in the chiller portion 400, and the first heat-exchange fluid having a relatively high temperature may transfer thermal energy to the second heat-exchange fluid having a relatively low temperature so that the first heat-exchange fluid may be cooled and then discharged from the chiller portion 400. Meanwhile, the chiller portion 400 may be a kind of heat-exchanger, and various types of heat-exchangers may be applied as the chiller portion 400. For example, the chiller portion 400 may be a plate-shaped heat-exchanger.

Meanwhile, the vehicle air conditioning line 500 may include i) a main line 305 that provides a route along which the second heat-exchange fluid flows in case that the air conditioner portion 300 operates to lower a temperature of the internal space of the vehicle by use of the air conditioner portion 300, and ii) a line branching off from the i) main line 305 to supply the second heat-exchange fluid to the chiller portion 400.

As illustrated in FIG. 2, the vehicle air conditioning line 500 may include a first branch line 510, as the line branching off from the main line 305, branching off from a portion of the vehicle air conditioning line 500, which connects the condenser 310 and the main expansion valve 320, and connected to the chiller portion 400.

In case that the air conditioner portion 300 operates, the second heat-exchange fluid may sequentially flow through the condenser 310, the main expansion valve 320, the evaporator 330, and the compressor 340 through the vehicle air conditioning line 500 to perform the general function of the air conditioner portion (i.e., a function of cooling the internal space of the vehicle). In the instant case, because the second heat-exchange fluid in the condenser 310 discharges thermal energy to the outside thereof, the second heat-exchange fluid discharged from the condenser 310 is in a relatively low-temperature state. That is, the second heat-exchange fluid discharged from the condenser 310 may have a temperature condition suitable for cooling the first heat-exchange fluid. Therefore, according to an exemplary embodiment of the present disclosure, the first branch line 510 may branch off from the portion of the vehicle air conditioning line 500 that connects the condenser 310 and the main expansion valve 320.

Meanwhile, the vehicle 10 according to an exemplary embodiment of the present disclosure may further include a branch expansion valve 750 mounted in the first branch line 510. That is, the second heat-exchange fluid, which flows through the first branch line 510, may pass through the branch expansion valve 750 before being supplied to the chiller portion 400. The pressure and temperature of the second heat-exchange fluid may decrease while the second heat-exchange fluid passes through the branch expansion valve 750.

Furthermore, with continued reference to FIG. 2, the vehicle air conditioning line 500 may further include a second branch line 520 configured to connect the chiller portion 400 and the compressor 340. Therefore, the second heat-exchange fluid, which is introduced into the chiller portion 400 through the first branch line 510, may exchange heat with the first heat-exchange fluid in the chiller portion 400 and then be supplied to the compressor 340 through the second branch line 520. Meanwhile, as illustrated in FIG. 2, an accumulator 800 may be mounted in the second branch line 520. The accumulator 800 may be configured to protect the compressor 340 by separating a liquid from the second heat-exchange fluid introduced toward the compressor 340.

Meanwhile, the cooling target component portion 100, which is configured to be cooled by the first heat-exchange fluid, may include a first cooling target component portion 110 and a second cooling target component portion 120 mounted separately from the first cooling target component portion 110. In the instant case, according to an exemplary embodiment of the present disclosure, the cooling line 200 may include a first cooling target line 210 through which the first heat-exchange fluid flows to cool the first cooling target component portion 110, and a second cooling target line 220 through which the first heat-exchange fluid flows to cool the second cooling target component portion 120.

The cooling line 200 may include the first cooling target line 210 through which the first heat-exchange fluid discharged from the chiller portion 400 is supplied to the first cooling target component portion 110, and the second cooling target line 220 through which the first heat-exchange fluid discharged from the chiller portion 400 is supplied to the second cooling target component portion 120.

In the instant case, as illustrated in FIG. 2, the first cooling target line 210 and the second cooling target line 220 may be disposed in parallel with each other. The configuration in which the two lines are disposed in parallel may mean that the first heat-exchange fluid, which is discharged from the chiller portion 400 and reaches the cooling line 200, is supplied selectively to the first cooling target line 210 or the second cooling target line 220 by a valve 230.

In an exemplary embodiment of the present disclosure, the valve 230 is a three-way valve connected to a controller including a processor configured to control operation of the three-way valve.

Meanwhile, the first cooling target component portion 110 may be one of the ICCU 111, the inverter 112, and the oil cooler 113, and the second cooling target component portion 120 may include the battery 121. Because the battery 121 generates a relatively large amount of heat, the battery 121 needs to be cooled to a relatively large extent. Therefore, the first heat-exchange fluid supplied to the second cooling target line 220 needs to be used to concentratedly cool the battery 121. Therefore, the battery 121 may be cooled in a line mounted separately from the lines in which other components in the cooling target component portion 100 are provided. Meanwhile, a temperature-raising heater 130 may be additionally mounted in the second cooling target line 220. The temperature-raising heater 130 may be mounted in an upstream region of the battery 121 based on a flow direction of the second heat-exchange fluid. The temperature-raising heater 130 may be configured to heat the battery 121 to meet a temperature condition required to initially operate the battery 121.

Meanwhile, the vehicle 10 according to an exemplary embodiment of the present disclosure may further include not only a configuration for lowering a temperature of the internal space of the vehicle but also a configuration for raising a temperature of the internal space of the vehicle.

With reference to FIG. 2, the vehicle air conditioning line 500 may further include a bypass line 530 extending from the main expansion valve 320 and mounted separately from the main line 305 that connects the main expansion valve 320 and the evaporator 330. The bypass line 530 may also be a part of the vehicle air conditioning line 500 and be configured to provide a route along which the second heat-exchange fluid flows. However, the bypass line 530 may provide the route along which the second heat-exchange fluid flows at the time of raising a temperature of the internal space of the vehicle.

Furthermore, the vehicle 10 according to an exemplary embodiment of the present disclosure may further include a heat pump condenser 600 connected to the compressor 340 through the vehicle air conditioning line 500 and configured to receive the second heat-exchange fluid discharged from the compressor 340. The heat pump condenser 600 may be configured to supply thermal energy to the internal space of the vehicle to raise a temperature of the internal space of the vehicle. For example, the heat pump condenser 600, together with the evaporator 330, may be mounted in one housing.

Meanwhile, the bypass line 530 may be connected to an upstream region of the condenser 310 based on the flow direction of the second heat-exchange fluid in the vehicle air conditioning line 500. The bypass line 530 may be connected to a downstream region of the heat pump condenser 600 based on the flow direction of the second heat-exchange fluid in the vehicle air conditioning line 500. That is, according to an exemplary embodiment of the present disclosure, the bypass line 530 may extend from the main expansion valve 320 and then be connected to a region of the vehicle air conditioning line 500 which is disposed between the condenser 310 and the heat pump condenser 600 based on the flow direction of the second heat-exchange fluid.

With continued reference to FIG. 2, the vehicle according to an exemplary embodiment of the present disclosure may further include a bypass line expansion valve 700 mounted in the bypass line 530. The pressure and temperature of the second heat-exchange fluid may decrease while the second heat-exchange fluid passes through the bypass line expansion valve 700.

Meanwhile, the vehicle 10 according to an exemplary embodiment of the present disclosure may further include an additional configuration for raising a temperature of the internal space of the vehicle. For example, as illustrated in FIG. 2, the vehicle 10 according to an exemplary embodiment of the present disclosure may further include a PTC heater 650. For example, the PTC heater 650 may be disposed adjacent to the heat pump condenser 600. The description of the operational principle of the PTC heater 650 may be replaced with the contents included in the related art.

Furthermore, the vehicle 10 according to an exemplary embodiment of the present disclosure may further include a reservoir 850 mounted in the cooling line 200 or the connection line 550 and configured to store the first heat-exchange fluid discharged from the first cooling target line 210 and the second cooling target line 220.

In an exemplary embodiment of the present disclosure, a pump 830 may be mounted in the connection line 550.

Hereinafter, a method of operating the vehicle according to an exemplary embodiment of the present disclosure will be described with reference to the above-mentioned description and the drawings.

### Vehicle Internal Component Cooling Step

The method of operating the vehicle according to an exemplary embodiment of the present disclosure may be a method of operating the vehicle including the cooling line 200 through which the first heat-exchange fluid for cooling the cooling target component portion 100 flows, the vehicle air conditioning line 500 through which the second heat-exchange fluid, which heats or cools the internal space of the vehicle which exchange heat with the internal space of the vehicle, flows, and the connection line 550 extending from the cooling line 200 toward the vehicle air conditioning line 500 and configured to define the region in which the first heat-exchange fluid and the second heat-exchange fluid exchange heat with each other.

In the instant case, the method of operating the vehicle according to an exemplary embodiment of the present disclosure may include a vehicle internal component cooling step of allowing the first heat-exchange fluid in the cooling line 200 to exchange heat with the cooling target component portion 100, supplying the first heat-exchange fluid to the connection line 550, and cooling the first heat-exchange fluid by allowing the first heat-exchange fluid to exchange heat with the second heat-exchange fluid in the connection line 550.

In the vehicle internal component cooling step, the second heat-exchange fluid may be discharged from the condenser 310 mounted in the vehicle air conditioning line 500 and then introduced into the chiller portion 400 mounted in the vehicle air conditioning line 500, and the first heat-exchange fluid and the second heat-exchange fluid may exchange heat with each other in the chiller portion 400. Furthermore, in the vehicle internal component cooling step, the second heat-exchange fluid discharged from the condenser 310 may pass through the branch expansion valve 750 mounted in the vehicle air conditioning line 500 and then be introduced into the chiller portion 400.

Meanwhile, the cooling target component portion 100 of the vehicle according to an exemplary embodiment of the present disclosure may include the first cooling target component portion 110, and the second cooling target component portion 120 mounted separately from the first cooling target component portion 110. In the instant case, according to an exemplary embodiment of the present disclosure, in the vehicle internal component cooling step, the first heat-exchange fluid may selectively exchange heat with the first cooling target component portion 110 or the second cooling target component portion 120 and then be supplied to the connection line 550. As illustrated in FIG. 2, the present configuration may be understood as being based on the fact that the first cooling target line 210 and the second cooling target line 220, which form the cooling line 200, are disposed in parallel, the first cooling target component portion 110 is mounted in the first cooling target line 210, and the second cooling target component portion 120 is mounted in the second cooling target line 220.

However, unlike the above-mentioned configuration, according to an exemplary embodiment of the present disclosure, in the vehicle internal component cooling step, the first heat-exchange fluid may sequentially exchange heat with the second cooling target component portion 120 and the first cooling target component portion 110 and then be supplied to the connection line 550. The present configuration may be understood as being based on the fact that the first cooling target line 210 and the second cooling target line 220, which form the cooling line 200, are disposed in series, the first cooling target component portion 110 is mounted on the first cooling target line 210, and the second cooling target component portion 120 is mounted on the second cooling target line 220.

As described above, in case that the first cooling target line 210 and the second cooling target line 220 are disposed in series, in the vehicle internal component cooling step, the second heat-exchange fluid may pass through the second cooling target line 220 first and then pass through the first cooling target line 210. This may be because the second cooling target component portion 120 mounted in the second cooling target line 220 generates a larger amount of heat than the first cooling target component portion 110 mounted in the first cooling target line 210. For example, the first cooling target component portion 110 may include at least one of the ICCU 111, the inverter 112, and the oil cooler 113, and the second cooling target component portion 120 may include the battery 121.

Meanwhile, in the vehicle internal component cooling step of the method of operating the vehicle according to an exemplary embodiment of the present disclosure, the first heat-exchange fluid may exchange heat with the cooling target component portion 100 in the front lower region of the vehicle, and the second heat-exchange fluid may flow in the upper region of the vehicle. In the instant case, in the vehicle internal component cooling step, the first heat-exchange fluid may exchange heat with the second heat-exchange fluid in the chiller portion 400 while flowing in the upper region of the vehicle 10 through the connection line 550.

Meanwhile, to cool the cooling target component portion 100, the second heat-exchange fluid is discharged from the condenser 310 of the air conditioner portion 300 and then passes through the branch expansion valve 750 through the first branch line 510 so that the pressure and temperature of the second heat-exchange fluid may decrease. Thereafter, the first heat-exchange fluid and the second heat-exchange fluid exchange heat with each other in the chiller portion 400 so that the temperature of the first heat-exchange fluid decreases, and the temperature of the second heat-exchange fluid increases. The first heat-exchange fluid discharged from the chiller portion 400 may cool the first cooling target component portion 110 or the second cooling target component portion 120 while flowing through the first cooling target line 210 or the second cooling target line 220. Meanwhile, the second heat-exchange fluid discharged from the chiller portion 400 may be supplied to the compressor 340 through the second branch line 520 and compressed.

### Vehicle Cooling Step

Meanwhile, the method of operating the vehicle according to an exemplary embodiment of the present disclosure may further include a vehicle cooling step of cooling the internal space of the vehicle 10 by allowing the second heat-exchange fluid to flow in the internal space of the vehicle 10.

In the vehicle cooling step, the second heat-exchange fluid may sequentially flow through the condenser 310, the main expansion valve 320, the evaporator 330, and the compressor 340 of the air conditioner portion 300 through the vehicle air conditioning line 500. The temperature of the second heat-exchange fluid in the condenser 310 may decrease while the second heat-exchange fluid discharges heat to the outside thereof, and the pressure and temperature of the second heat-exchange fluid discharged from the condenser 310 may decrease while the second heat-exchange fluid passes through the main expansion valve 320. Furthermore, the temperature of the second heat-exchange fluid discharged from the main expansion valve 320 may increase as the second heat-exchange fluid receives thermal energy from the internal space of the vehicle while passing through the evaporator 330, and the pressure and temperature of the second heat-exchange fluid discharged from the evaporator 330 may increase while the second heat-exchange fluid passes through the compressor 340. Furthermore, the above-mentioned processes may be repeated as the second heat-exchange fluid discharged from the compressor 340 is supplied back to the condenser 310.

Meanwhile, according to an exemplary embodiment of the present disclosure, the vehicle internal component cooling step and the vehicle cooling step may be performed at least partially together in a time series manner. In case that the vehicle internal component cooling step and the vehicle cooling step are performed together in a time series manner, the vehicle cooling step may include allowing a part of the second heat-exchange fluid, which is discharged from the condenser 310 mounted in the vehicle air conditioning line 500, to sequentially pass through the main expansion valve 320, the evaporator 330, and the compressor 340 mounted in the vehicle air conditioning line 500, and the vehicle internal component cooling step may include introducing another part of the second heat-exchange fluid, which is discharged from the condenser 310, into the chiller portion 400 mounted in the vehicle air conditioning line 500. Therefore, in case that the vehicle internal component cooling step and the vehicle cooling step are performed together in a time series manner, a part of the second heat-exchange fluid in the evaporator 330 cools the interior of the vehicle by absorbing thermal energy in the vehicle and discharging thermal energy to the outside of the vehicle from the condenser 310, and another part of the second heat-exchange fluid exchanges heat with the first heat-exchange fluid in the chiller portion 400 so that the first heat-exchange fluid may cool the cooling target component portion 100.

### Vehicle Heating Step

The method of operating the vehicle according to an exemplary embodiment of the present disclosure may further include a vehicle heating step of heating the internal space of the vehicle 10 by allowing the second heat-exchange fluid to flow in the internal space of the vehicle 10. In the instant case, according to an exemplary embodiment of the present disclosure, the vehicle internal component cooling step and the vehicle heating step may be performed at least partially together in a time series manner.

In case that the vehicle internal component cooling step and the vehicle heating step are performed together in a time series manner, the vehicle internal component cooling step and the vehicle heating step may each include allowing at least a part of the second heat-exchange fluid, which is discharged from the condenser 310 mounted in the vehicle air conditioning line 500, to sequentially pass through the branch expansion valve 750, the chiller portion 400, the compressor 340, and the heat pump condenser 600 mounted in the vehicle air conditioning line 500, allowing the second heat-exchange fluid to exchange heat with the first heat-exchange fluid in the chiller portion 400, and supplying thermal energy to the internal space of the vehicle 10 from the heat pump condenser 600. That is, it may be understood that in case that the vehicle internal component cooling step and the vehicle heating step are performed together in a time series manner, the thermal energy, which is recovered from the cooling target component portion 100 by the first heat-exchange fluid, is transferred to the second heat-exchange fluid from the chiller portion 400 and then transferred to the internal space of the vehicle 10 from the heat pump condenser 600.

Processes, which are performed by the components through which the second heat-exchange fluid passes in case that the vehicle internal component cooling step and the vehicle heating step are performed together in a time series manner as described above, will be described below in detail. First, the temperature and pressure of the second heat-exchange fluid in the compressor 340 increase as the second heat-exchange fluid is compressed, and the temperature of the second heat-exchange fluid discharged from the compressor 340 decreases in the heat pump condenser 600 as the second heat-exchange fluid supplies thermal energy to the internal space of the vehicle. The second heat-exchange fluid discharged from the heat pump condenser 600 may additionally discharge a part of the thermal energy from the condenser 310 to the outside of the vehicle, and the pressure and temperature of the second heat-exchange fluid discharged from the condenser 310 may decrease as the second heat-exchange fluid passes through the branch expansion valve 750. The second heat-exchange fluid including passed through the branch expansion valve 750 may be supplied to the chiller portion 400 and then exchange heat with the first heat-exchange fluid so that the temperature of the second heat-exchange fluid may increase. The above-mentioned processes may be repeated as the second heat-exchange fluid discharged from the chiller portion 400 is supplied back to the compressor 340.

In contrast, unlike the above-mentioned configuration, the vehicle heating step may be separately performed independently of the vehicle internal component cooling step.

The vehicle heating step may further include allowing the second heat-exchange fluid to sequentially pass through the evaporator 330, the compressor 340, the heat pump condenser 600, and the bypass line expansion valve 700 mounted in the vehicle air conditioning line 500, and supplying thermal energy to the internal space of the vehicle from the heat pump condenser 600. That is, in the instant case, the second heat-exchange fluid may sequentially flow through the evaporator 330, the compressor 340, the heat pump condenser 600, and the bypass line expansion valve 700 through the vehicle air conditioning line 500 including the bypass line 530. The temperature of the second heat-exchange fluid in the evaporator 330 increases as the second heat-exchange fluid receives thermal energy, and the pressure and temperature of the second heat-exchange fluid discharged from the evaporator 330 increase as the second heat-exchange fluid is compressed in the compressor 340. The second heat-exchange fluid discharged from the compressor 340 is supplied to the heat pump condenser 600. The temperature of the second heat-exchange fluid in the heat pump condenser 600 decreases as the second heat-exchange fluid supplies thermal energy to the internal space of the vehicle, and the pressure and temperature of the second heat-exchange fluid discharged from the heat pump condenser 600 decrease as the second heat-exchange fluid passes through the bypass line expansion valve 700 through the bypass line 530. The above-mentioned processes may be repeated as the second heat-exchange fluid discharged from the bypass line expansion valve 700 is supplied back to the evaporator 330.

Meanwhile, the above-mentioned two types of vehicle heating methods may be performed together in the vehicle according to an exemplary embodiment of the present disclosure. For example, in the vehicle heating step, the above-mentioned two types of vehicle heating methods may be performed together in a time series manner or performed separately in a time series manner.

Meanwhile, the vehicle 10 according to an exemplary embodiment of the present disclosure may be applied not only to vehicles with general shapes but also to new types of movable bodies such as purpose-built vehicles (PBVs). According to an exemplary embodiment of the present disclosure, it is possible to effectively dissipate heat generated from the cooling target component portion without a radiator in related art, which may contribute to reducing heights of platforms of the movable bodies including the PBVs.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method of operating a vehicle, which includes a cooling line through which a first heat-exchange fluid for cooling a cooling target component portion flows, a vehicle air conditioning line through which a second heat-exchange fluid, which heats or cools an internal space of the vehicle while exchanging heat with the internal space of the vehicle, flows, and a connection line extending from the cooling line toward the vehicle air conditioning line and configured to define a region in which the first heat-exchange fluid and the second heat-exchange fluid exchange heat with each other, the method comprising:
a component cooling step of allowing the first heat-exchange fluid in the cooling line to exchange heat with the cooling target component portion, supplying the first heat-exchange fluid to the connection line, and cooling the first heat-exchange fluid by allowing the first heat-exchange fluid to exchange heat with the second heat-exchange fluid in the connection line.

2. The method of claim 1, wherein in the vehicle internal component cooling step, the second heat-exchange fluid is discharged from a condenser mounted in the vehicle air conditioning line and then introduced into a chiller portion mounted in the vehicle air conditioning line, and the first heat-exchange fluid and the second heat-exchange fluid exchange heat with each other in the chiller portion.

3. The method of claim 2, wherein in the vehicle internal component cooling step, the second heat-exchange fluid discharged from the condenser passes through a branch expansion valve mounted in the vehicle air conditioning line and then is introduced into the chiller portion.

4. The method of claim 1, wherein the cooling target component portion includes:
a first cooling target component portion; and
a second cooling target component portion mounted separately from the first cooling target component portion, and
wherein in the vehicle internal component cooling step, the first heat-exchange fluid selectively exchanges heat with the first cooling target component portion or the second cooling target component portion and then is supplied to the connection line.

5. The method of claim 1, wherein the cooling target component portion includes:
a first cooling target component portion; and
a second cooling target component portion property separately from the first cooling target component portion, and
wherein in the vehicle internal component cooling step, the first heat-exchange fluid sequentially exchanges heat with the second cooling target component portion and the first cooling target component portion and then is supplied to the connection line.

6. The method of claim 4, wherein the first cooling target component portion includes at least one of an integrated charging control unit (ICCU), an inverter, and an oil cooler, and the second cooling target component portion includes a battery.

7. The method of claim 1, wherein in the vehicle internal component cooling step, the first heat-exchange fluid exchanges heat with the cooling target component portion in a front lower region of the vehicle, and the second heat-exchange fluid flows in an upper region of the vehicle.

8. The method of claim 7, wherein in the vehicle internal component cooling step, the first heat-exchange fluid exchanges heat with the second heat-exchange fluid while flowing in the upper region of the vehicle through the connection line.

9. The method of claim 1, further including:
a vehicle cooling step of cooling the internal space of the vehicle by allowing the second heat-exchange fluid to flow in the internal space of the vehicle,
wherein the vehicle internal component cooling step and the vehicle cooling step are performed at least partially together in a time series manner.

10. The method of claim 9, wherein when the vehicle internal component cooling step and the vehicle cooling step are performed together in a time series manner, the vehicle cooling step includes allowing a part of the second heat-exchange fluid, which is discharged from a condenser mounted in the vehicle air conditioning line, to sequentially pass through a main expansion valve, an evaporator, and a compressor mounted in the vehicle air conditioning line, and the vehicle internal component cooling step includes introducing another part of the second heat-exchange fluid discharged from the condenser into a chiller portion mounted in the vehicle air conditioning line.

11. The method of claim 1, further including:
a vehicle heating step of heating the internal space of the vehicle by allowing the second heat-exchange fluid to flow in the internal space of the vehicle,
wherein the vehicle internal component cooling step and the vehicle heating step are performed at least partially together in a time series manner.

12. The method of claim 11, wherein when the vehicle internal component cooling step and the vehicle heating step are performed together in a time series manner, the vehicle internal component cooling step and the vehicle heating step include allowing at least a part of the second heat-exchange fluid, which is discharged from a condenser mounted in the vehicle air conditioning line, to sequentially pass through a branch expansion valve, a chiller portion, a compressor, and a heat pump condenser mounted in the vehicle air conditioning line, allowing the second heat-exchange fluid to exchange heat with the first heat-exchange fluid in the chiller portion, and then supplying thermal energy to the internal space of the vehicle from the heat pump condenser.

13. The method of claim 1, further including:
a vehicle heating step of heating the internal space of the vehicle by allowing the second heat-exchange fluid to flow in the internal space of the vehicle,
wherein the vehicle heating step includes allowing the second heat-exchange fluid to sequentially pass through an evaporator, a compressor, a heat pump condenser, and a bypass line expansion valve mounted in the vehicle air conditioning line, and supplying thermal energy to the internal space of the vehicle from the heat pump condenser.

14. A vehicle, comprising:
at least a cooling target component portion including a cooling line, wherein a first heat-exchange fluid flows in the cooling line;
an air conditioning portion including a vehicle air conditioning line, wherein a second heat-exchange fluid flows in the vehicle air conditioning line;
a connection line extending from the cooling line toward the vehicle air conditioning line and configured to define a region in which the first heat-exchange fluid and the second heat-exchange fluid exchange heat with each other; and
a valve connected to the connection line between the air conditioning portion and the at least a cooling target component portion and selectively connecting the air conditioning portion and the at least a cooling target component portion.

15. The vehicle of claim 14,
wherein the vehicle air conditioning line includes a main line, a first branch line, a second branch line and a bypass line, the first branch line, the second branch line and the bypass line branching from the main line,
wherein the air conditioning portion further includes:
a condenser mounted in the main line; and
a chiller portion mounted in the main line and the first branch line,
wherein the first heat-exchange fluid and the second heat-exchange fluid exchange heat with each other in the chiller portion.

16. The vehicle of claim 15, further including a bypass line expansion valve mounted in the bypass line of the vehicle air conditioning line.

17. The vehicle of claim 14,
wherein the cooling line includes a first cooling target line and a second cooling target line, the first cooling target line and the second cooling target line connected to the valve and the valve selectively connects the connection line to at least one of the first cooling target line and the second cooling target line,
wherein the at least a cooling target component portion further includes:
a first cooling target component portion mounted in the first cooling target line; and
a second cooling target component portion mounted in the second cooling target line in parallel to the first cooling target component portion.

18. The vehicle of claim 17, wherein the first cooling target component portion includes at least one of an integrated charging control unit (ICCU), an inverter, and an oil cooler, and the second cooling target component portion includes a battery.

19. The vehicle of claim 15, wherein the air conditioning portion further includes a main expansion valve, and an evaporator, and a compressor connected to the main line.

20. The vehicle claim 19,
wherein the air conditioning portion further includes a heat pump condenser connected to the compressor and the condenser, and
wherein the heat pump condenser is mounted in parallel to the evaporator.
